(19) United States
(12) Patent Application Publication
(10) Pub. No.: US 2022/0406122 A1
(43) Pub. Date: Dec. 22, 2022

(54) Methods and Apparatuses for Controlling Game States

(71) Applicant: SENSETIME INTERNATIONAL PTE. LTD., Singapore (SG)

(72) Inventors: Fei Xie, Singapore (SG); Xinxin Wang, Singapore (SG)

(21) Appl. No.: 17/363,535

(22) Filed: Jun. 30, 2021

Related U.S. Application Data
(63) Continuation of application No. PCT/IB2021/055670, filed on Jun. 25, 2021.

(30) Foreign Application Priority Data
Jun. 18, 2021 (SG) 10202106647X

(51) Int. Cl. G07F 17/32

(52) U.S. Cl. CPC G07F 17/3206; G07F 17/322; G07F 17/3241

(57) ABSTRACT

The present disclosure relates to the field of computer vision technology, and in particular to a method and an apparatus for controlling game states. The method of controlling game states includes: obtaining a sequence of image frames of a game table on which a game is in a halt state, where the game table includes a currency token operating area and a game item operating area; in response to detecting that one or more currency tokens in the currency token operating area are operated by a preset operating object based on one or more image frames in the sequence of image frames, obtaining detection information of one or more game items in the game item operating area from the one or more image frames, where the detection information includes identification information of each of the one or more game items; and in a case that the identification information meets a preset game result generation condition, switching the game from the halt state to a result processing state.

### CROSS-REFERENCE TO RELATED APPLICATION

The present application is a continuation of International Application No. PCT/IB2021/055670 filed on Jun. 25, 2021, which claims priority to Singapore Patent Application No. 10202106647X, filed on Jun. 18, 2021, all of which are incorporated herein by reference in their entirety.

### TECHNICAL FIELD

The present disclosure relates to the field of computer vision technology, and in particular to a method and an apparatus for controlling game states.

### BACKGROUND

At present, detection of scenario activity based on computer vision has been widely applied in various scenarios. For scenarios such as tabletop games, a detection system is needed to implement switch between different game states with development of the game process.

### SUMMARY

In a first aspect, implementations of the present disclosure provide a method of controlling game states, including: obtaining a sequence of image frames of a game table on which a game is in a halt state, where the game table includes a currency token operating area and a game item operating area; in response to detecting that one or more currency tokens in the currency token operating area are operated by a preset operating object based on one or more image frames in the sequence of image frames, obtaining detection information of one or more game items in the game item operating area from the one or more image frames, where the detection information includes identification information of each of the one or more game items; and in a case that the identification information meets a preset game result generation condition, switching the game from the halt state to a result processing state.

In some implementations, obtaining the detection information of the one or more game items in the game item operating area from the one or more image frames includes: obtaining a number of game items in the game item operating area and the identification information of each game item by performing game item detection on the one or more image frames.

In some implementations, the method further includes: determining a first preset condition corresponding to the number of game items; and in response to determining that the first preset condition is satisfied based on the detected identification information of each game item, determining that the identification information meets the preset game result generation condition.

In some implementations, the method further includes: detecting an operation on one or more currency tokens in the currency token operating area based on the sequence of image frames.

In some implementations, detecting the operation on the one or more currency tokens in the currency token operating area based on the sequence of image frames includes: detecting a change of the one or more currency tokens in the currency token operating area based on the sequence of image frames; in response to detecting a change of the one or more currency tokens, determining whether the change of the one or more currency tokens is caused by a preset operating object; and in response to determining that the change of the one or more currency tokens is caused by the preset operating object, determining that the preset operating object is detected to operate the currency tokens in the currency token operating area.

In some implementations, determining whether the change of the one or more currency tokens is caused by the preset operating object includes: detecting whether an operation tool correlated with the changed currency tokens belongs to the preset operating object based on the sequence of image frames.

In some implementations, the preset operating object includes a preset person, the operation tool includes a hand, and detecting whether the operation tool correlated with the changed currency tokens belongs to the preset operating object based on the sequence of image frames includes: detecting a target hand correlated with the changed currency tokens based on the sequence of image frames; detecting a target face correlated with the target hand based on the sequence of image frames; determining whether the target hand belongs to the preset person according to the recognition result of the target face.

In some implementations, obtaining the detection information of the one or more game items in the game item operating area from the one or more image frames includes: reading the detection information of the one or more game items in the game item operating area from a cache, where the detection information of the one or more game items is generated by: sequentially taking each image frame in the sequence of image frames as an interested image, performing game item detection on the interested image to obtain a game item detection result of the interested image; and based on a comparison result between the game item detection result of the interested image and a game item detection result in the cache, updating the game item detection result in the cache.

In some implementations, the method further includes: in a case that the identification information does not meet the preset game result generation condition, in response to receiving a manual switching instruction for switching the game to a currency token operating state, switching the game to the currency token operating state, and clearing the game item detection result in the cache.

In a second aspect, implementations of the present disclosure provide an apparatus for controlling game states, including: a first obtaining module configured to obtain a sequence of image frames of a game table on which a game is in a halt state, where the game table includes a currency token operating area and a game item operating area; a second obtaining module configured to, in response to detecting that one or more currency tokens in the currency token operating area are operated by a preset operating object based on one or more image frames in the sequence of image frames, obtain detection information of one or more game items in the game item operating area from the one or more image frames, where the detection information includes identification information of each of the one or more game items; and a state switching module configured to, in a case that the identification information meets a preset game result generation condition, switch the game from the halt state to a result processing state.

In some implementations, the second obtaining module is specifically configured to: obtain a number of game items in the game item operating area and the identification information of each game item by performing game item detection on the one or more image frames.

In some implementations, the apparatus further includes a determining module configured to: determine a first preset condition corresponding to the number of game items; and in response to determining that the first preset condition is satisfied based on the detected identification information of each game item, determine that the identification information meets the preset game result generation condition.

In some implementations, the apparatus further includes: a detecting module configured to detect an operation on one or more currency tokens in the currency token operating area based on the sequence of image frames.

In some implementations, the detecting module is specifically configured to: detect a change of the one or more currency tokens in the currency token operating area based on the sequence of image frames; in response to detecting a change of the one or more currency tokens, determine whether the change of the one or more currency tokens is caused by a preset operating object; and in response to determining that the change of the one or more currency tokens is caused by the preset operating object, determine that the preset operating object is detected to operate the currency tokens in the currency token operating area.

In some implementations, the detecting module is specifically configured to: detect whether an operation tool correlated with the changed currency tokens belongs to the preset operating object based on the sequence of image frames.

In some implementations, the preset operating object includes a preset person, the operation tool includes a hand, and the detecting module is specifically configured to: detect a target hand correlated with the changed currency tokens based on the sequence of image frames; detect a target face correlated with the target hand based on the sequence of image frames; and determine whether the target hand belongs to the preset person according to a recognition result of the target face.

In some implementations, the second obtaining module is specifically configured to: read the detection information of the one or more game items in the game item operating area from a cache, where the detection information of the one or more game items is generated by: sequentially taking each image frame in the sequence of image frames as an interested image, performing game item detection on the interested image to obtain a game item detection result of the interested image; and based on a comparison result between the game item detection result of the interested image and a game item detection result in the cache, updating the game item detection result in the cache.

In some implementations, the apparatus further includes: a manual switching module configured to, in a case that the identification information does not meet the preset game result generation condition, in response to receiving a manual switching instruction for switching the game to a currency token operating state, switch the game to the currency token operating state, and clear the game item detection result in the cache.

In a third aspect, implementations of the present disclosure provide a detection system including: a processor; and a memory storing computer instructions for causing the processor to execute the method in any one of the implementations in the first aspect.

In a fourth aspect, implementations of the present disclosure provide a storage medium storing computer instructions for causing a computer to perform the method in any one of the implementations in the first aspect.

The method of controlling game states provided by the implementations of the present disclosure includes: obtaining a sequence of image frames of a game table on which a game is in a halt state, where the game table includes a currency token operating area and a game item operating area; when detecting that one or more currency tokens in the currency token operating area are operated by a preset operating object based on at least one image frame in the sequence of image frames, obtaining detection information of one or more game items in the game item operating area from the at least one image frame, where the detection information includes identification information of each of the game items; and when the identification information meets a preset game result generation condition, switching the game from the halt state to a result processing state. The detection of a game scene is realized based on computer vision in the method of this disclosure, which ensures that the game process is standardized and smooth progressed. And when the game is in the halt state, through the detection of the identification information of the game items, the game can be automatically switched to the result processing state in a case where the identification information meets the preset game result generation condition, such that the game is automatically resumed without requiring the user to switch manually, and the reliability and stability of the system are improved.

### BRIEF DESCRIPTION OF THE DRAWINGS

In order to more clearly illustrate the specific embodiments of the present disclosure or the technical solutions in the prior art, accompanying drawings to be referred in the specific embodiments or the description of the prior art will be briefly introduced below. Apparently, the accompanying drawings in the following description show some embodiments of the present disclosure. For those of ordinary skill in the art, other drawings can be obtained based on these drawings without creative endeavor.

FIG. 1 is a schematic structural diagram of a detection system according to some implementations of the present disclosure.

FIG. 2 is a flowchart of a method of controlling game states according to some implementations of the present disclosure.

FIG. 3 is a flowchart of a method of controlling game states according to some implementations of the present disclosure.

FIG. 4 is a flowchart of a method of controlling game states according to some implementations of the present disclosure.

FIG. 5 is a flowchart of a method of controlling game states according to some implementations of the present disclosure.

FIG. 6 is a flowchart of a method of controlling game states according to some implementations of the present disclosure.

FIG. 7 is a flowchart of a method of controlling game states according to some implementations of the present disclosure.

FIG. 8 is a structural block diagram of an apparatus for controlling game states according to some implementations of the present disclosure.

FIG. 9 is a structural block diagram of an apparatus for controlling game states according to some implementations of the present disclosure.

FIG. 10 is a structural block diagram of a computer system applicable for implementing the method of the present disclosure.

### DETAILED DESCRIPTION OF THE EMBODIMENTS

The technical solutions of the present disclosure will be clearly and completely described below in conjunction with the accompanying drawings. Apparently, the described implementations are part of the implementations of the present disclosure, rather than all of the implementations. Based on the implementations in the present disclosure, all other implementations obtained by those of ordinary skill in the art without creative endeavor shall fall within the protection scope of the present disclosure. In addition, the technical features involved in the different embodiments of the present disclosure described below can be combined with each other as long as they do not conflict with each other.

A complete game can often be divided into a plurality of different stages according to different player actions. For example, for a tabletop card game, the game process can include players placing game coins, a dealer dealing cards, and collecting and settling the game coins according to the card results, and so on. For each game stage, the game stage often has a certain game rule. For example, in a stage of dealing cards, a certain requirement is generally provided on the order of dealing cards.

A detection system based on computer vision can divide the entire game process into multiple different game states according to the different game stages. For example, the card dealing stage can correspond to a “card dealing state”, and the game coins clearing and settling stage can correspond to a “result processing state”. At a logic level, the detection system can set corresponding detection logic based on different game stages, so as to determine whether a player is performing a game action according to a proper game rule when the game is in the current state. For example, when cheating, violations, and other actions that can cause major losses to other players are detected, the game can be switched to a halt state instantly, and warning information can be issued at the same time.

In this scenario, the detection system is expected to automatically resume the game from the halt state to a normal state after the game order is restored. For example, the detection system detects that a player is placing game coins during the card dealing stage, and placing game coins during the card dealing stage is a violation action. Therefore, the detection system switches the game from the card dealing state to the halt state. However, after the player corrects the violation action, if the detection system still thinks that the game remains in the halt state, the detection system will not be able to effectively detect the subsequent game process. If state resuming relies on manual operation, the reliability of which can also be very low.

Based on the above, the implementations of the present disclosure provide a method and an apparatus for controlling game states, a detection system, and a storage medium, with an objective of automatically switching a game from a halt state to a normal state based on visual information during the game, so that the detection system can resume the detection of the game in a timely manner, and improve the reliability and stability of the system.

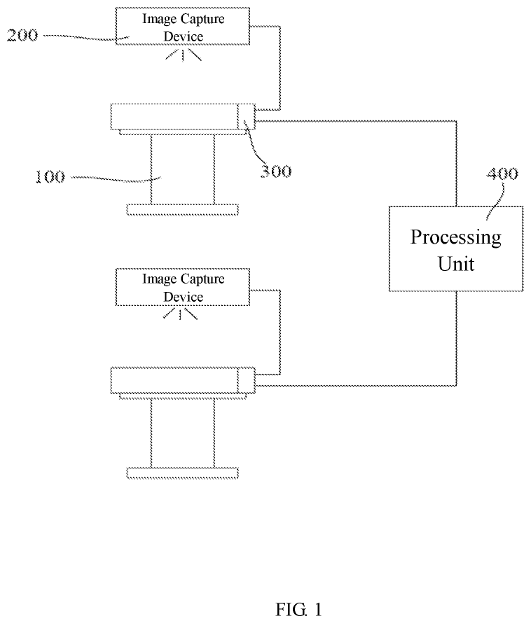

In some implementations, examples of the present disclosure provide a method of controlling game states, which can be applied to a detection system to realize visual detection on game scenarios. FIG. 1 shows some implementations of the detection system of the present disclosure, which will be described below in conjunction with FIG. 1.

As shown in FIG. 1, in some exemplary scenarios, the game of the present disclosure can be a tabletop game as an example. In this scenario, at least one game table 100 can be provided. In the implementation of the present disclosure, the number of game tables 100 is not limited. For example, two game tables 100 are shown in FIG. 1. It can be understood that the game table 100 indicates a carrier for players to play games, and the table top of the game table 100 indicates a game area where the players play games.

The detection system includes an image capture device 200 arranged above the game table 100, and the image capture device 200 is configured to obtain image data of the game area above the game table 100. For example, during the course of the game, a sequence of image frames of the game table can be collected by the image capture device 200.

In some implementations, the image capture device 200 includes at least one camera located directly above the game table 100, so that the image data of the game table can be accurately collected. In some preferred implementations, in addition to the camera directly above, the image capture device 200 can also include a plurality of cameras located on the sides of the game table 100, so that image data of the game from other angles can be collected. It can be understood by those skilled in the art, and will not be repeated in the present disclosure.

Still referring to FIG. 1, in an example of the present disclosure, the detection system further includes a vision unit 300 provided on each game table 100. The vision unit 300 can perform corresponding image processing operations, such as image detection and identification, based on the sequence of image frames collected by the image collection device 200. The vision unit 300 can be a unit module that is pre-trained based on a learnable machine learning model or a neural network model and can be used to identify and detect a target object in a sequence of image frames.

The detection system also includes a processing unit 400, which is respectively connected to the vision units 300 of a plurality of game tables 100, so that the processing unit 400 can obtain a processing result of each of the vision units 300, and perform corresponding steps according to the received processing results, for example, issuing control instructions to the vision unit 300 and so on.

In an exemplary scenario, when a vision unit 300 of a game table 100 detects that a player is not playing the game according to the rule of the game based on the image data collected by the image capture device 200, the vision unit 300 can send warning information to the processing unit 400. At the same time, the vision unit 300 can switch the current game to the halt state. After receiving the warning information, the processing unit 400 in the background can issue a warning to a dealer to give a risk alarm.

In the detection system exemplified in the present disclosure, a vision unit 300 is correspondingly provided for each game table, thereby facilitating the distributed management of the detection system.

However, it can be understood that the detection system of the implementation of the present disclosure is not limited to the example in FIG. 1, and other implementations are also possible based on the example in FIG. 1. For example, the vision unit 300 and the processing unit 400 can be integrated in the same processing module, that is, the vision unit 300 is not set on the game table 100 at the front end, but is integrated with the processing unit 400 in the background, and performs image data processing operations in the background. It can be understood by those skilled in the art, and will not be repeated in the present disclosure.

Based on the architecture of the detection system illustrated in FIG. 1, the method of controlling game states of the implementation of the present disclosure will be described below. The method exemplified in the present disclosure can be executed by the above-mentioned vision unit 300, can also be executed by the processing unit 400, or jointly executed by the vision unit 300 and the processing unit 400, which is not limited in the present disclosure.

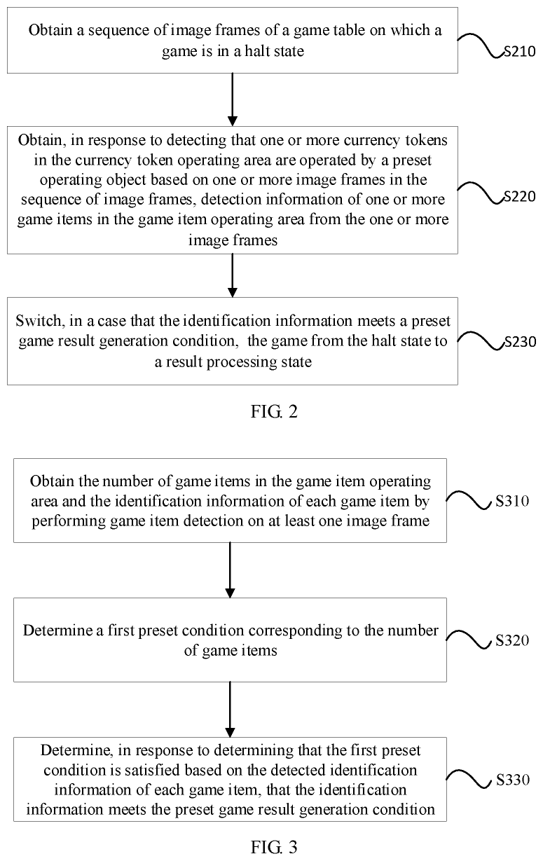

As shown in FIG. 2, in some implementations, the method of controlling game states of the example of the present disclosure includes the following step.

At S210, obtaining a sequence of image frames of a game table on which a game is in a halt state.

Based on the above, in the detection system of the implementation of the present disclosure, the game can be logically divided into a plurality of different game states according to the different stages of the game process. The detection system implements switch of game states based on a sequence of collected image frames, as the game progresses.

The halt state is different from the normal state when the game is in normal progress, that is, the halt state is not a state that must exist during the game, but a state when a violation action is detected based on the sequence of image frames.

In one example, taking a tabletop card game as an example, for example, when a mistake in the order of dealing cards is detected when the game is in a card dealing state, the game can be switched to the halt state. For another example, when the game is in a result processing state, when it is detected that a card has its back facing upwards, and valid identification information cannot be detected, the game can be switched to the halt state. Specific description of the halt state will be described in the following, and will not be described in detail here.

It can be understood that the halt state indicates a warning state when the game process indicating abnormal. If the detection system thinks that the game remains in the halt state, detection on the real game scenario cannot be effectively performed, that is, the game needs to be switched from the halt state to the normal state.

In some implementations, after the game enters the halt state, a sequence of image frames of the game table collected by an image capture device, for example, provided around the game table can be obtained, and the sequence of image frames represents video stream data of the game table area.

In the implementation of the present disclosure, a game area of the game table includes a currency token operating area and a game item operating area. Currency tokens refer to objects used to substitute currency in the game scenario, such as game coins. Therefore, the currency token operating area refers to an area of a game table used to operate currency tokens. Game items can be understood as game props, which are essential props for the game to proceed, such as cards in a tabletop card game. Therefore, the game item operating area refers to an area of a game table used for operating game items.

In one example, taking a tabletop card game as an example, the game area of the game table is divided into a plurality of sub-areas, including a currency token operating area and a game item operating area. The currency token operating area is used to place currency tokens, such as game coins, by a player in the area, for example, when the game is in a currency token operating state. The game item operating area is used to place game items, for example, playing cards in a card dealing state.

Therefore, in the implementation of the present disclosure, each image frame in the obtained sequence of image frames of the game table includes data information of the currency token operating area and the game item operating area.

At S220, obtaining, in response to detecting that one or more currency tokens in the currency token operating area are operated by a preset operating object based on one or more image frames in the sequence of image frames, detection information of one or more game items in the game item operating area from the one or more image frames.

Specifically, in a real game scenario, when the game moves from one game stage to another game stage, players or the dealer often perform certain processing operations. Therefore, at the logic level of the detection system, when the game is in the halt state, by detecting the processing operations of the preset operating object, it can be determined whether to switch the game state.

For example, in a real card game scenario, after determining a game result based on card information, a dealer will collect and settle the game coins in the currency token operating area according to the game result. Therefore, in the implementations of the present disclosure, it is possible to detect the operation of a dealer to collect the game coins based on the collected visual information of the game table, and use this operation as a response condition for state switching.

Specifically, the preset operating object can be a predetermined operating object, such as a player, a dealer, etc., which can be implemented by a person skilled in the art according to a specific scenario, which is not limited in the present disclosure.

Based on the obtained sequence of image frames, for example, with image detection technology, a case of detecting that one or more currency tokens in the currency token operating area are operated by the preset operating object based on at least one image frames in the sequence of image frames, it can mean that the real game scenario has entered the result processing stage. At this time, detection information of the game items in the game item operating area can be obtained, and the detection information includes identification information of each of the game items.

Taking a card game as an example, in the card dealing stage, for example, due to a mistake of the dealer in the order of dealing cards, the detection system switches the current game to the halt state. In a real game scenario, after the dealer deals cards again and obtains a game result, the dealer collects and settles the game coins. At this time, the detection system can detect the action of the dealer taking the game coins. At this time, detection information of the game items in the game item operating area can be obtained.

The identification information can indicate a prop attribute of the game item. For the purpose of distinguishing game items of the same kind, a plurality of different kinds of attribute information can be provided for the game items of one kind. The identification information described in the present disclosure refers to the attribute information of the game item.

In an example, taking a tabletop card game as an example, the game item can be a card, and the suit and point on the card is the identification information of the card, such as ace of hearts, 2 of spades, and so on.

In another example, taking a tabletop mahjong game as an example, the game item can be a mahjong block, and face information of the mahjong block is the identification information, such as ten character, nine bamboo, and so on.

However, those skilled in the art can understand that the implementations of the present disclosure are not limited to the above examples, and can also be applied to any other game scenarios suitable for implementation, which is not limited in the present disclosure.

The image capture device set above the game table can collect the sequence of image frames of the game table, and each image frame in the sequence of image frames includes all the game items in the game item operating area and the identification information of each of the game items. Therefore, with the image detection technology, the identification information of each game item in the game item operating area can be extracted and identified, so as to obtain the identification information of each game item.

It can be understood that the obtained sequence of image frames includes a plurality of consecutive image frames. In the implementation of the present disclosure, each of the image frames can be detected in sequence, and the detection result can be stored in a cache. Therefore, in some implementations, the detection result of the game items for the current image frame can be used to update the detection result obtained from a previous image frame, so as to obtain the latest detection result. The detection result update will be described in the following, and will not be described in detail here.

At S230, switching, in a case that the identification information meets a preset game result generation condition, the game from the halt state to a result processing state.

The game result generation condition can be a logical determination condition set in advance based on a game rule. A game result can be used to indicate the end of a game. For example, the winning and losing outcome of the game can be obtained according to the game result.

In the implementations of the present disclosure, the preset game result generation condition can refer to a condition under which the game result can be obtained according to the identification information of the game items.

In an example, the game scenario is for example a tabletop card game, and the game rule corresponding to the preset game result generation condition is that: the game item operating area includes at least 4 cards, and the party who received cards with a sum of points closest to 9 wins. Thus, the number of cards is detected based on the sequence of image frames. If the number of cards is less than 4, it is determined that a game result cannot be obtained, that is, the identification information of the game items in the current game item operating area does not meet the preset game result generation condition. And if the number of cards is greater than or equal to 4, and there is one party who received cards with the sum of points closer to 9 than the other party, it is determined that a game result can be obtained, that is, the identification information of the game items in the current game item operating area meets the preset game result generation condition.

Those skilled in the art can understand that the above examples are only used to illustrate the methods of the implementations of the present disclosure, and do not limit the present disclosure. The preset game result generation condition can be set according to specific game scenarios, and the present disclosure does not limit this.

When the identification information meets the preset game result generation condition, it indicates that the game result is already available in the current real game process, and it also indicates that the current game is in a normal state. Therefore, at the logic level of the detection system, the current halt state can be switched to the result processing state, so as to correspond to the real game stage and implement the detection of the result processing stage.

In an example, still taking the card game scenario as an example, when detecting by the detection system that the current game is in the halt state, according to the collected sequence of image frames of the game table, it is detected that the number of cards in the current game item operating area is greater than 4 and one party who received cards with a sum of points closer to 9 than the other party, then in the corresponding real game scenario, a player has already obtained a game result based on the card points and the game has entered the result processing stage. At this time, the detection system can determine at the logical level that the identification information meets the preset game result generation condition, thereby switching the game from the halt state to the result processing state corresponding to the result processing stage.

It can be understood that when the identification information does not meet the preset game result generation condition and the current game is in the halt state, the current game can remain in the halt state.

It can be seen from the above that in the method of controlling game states of the present disclosure, automatic state switch unconceivable to a front-end player can be achieved, and when the game is in the halt state, the dealer does not need to manually switch to resume the game from the halt state, which ensures the game process be smooth. It can realize continuous detection of the game process, and improve the reliability and stability of the system.

In some game scenarios, depending on the number of game items, the corresponding game rule is also different. For example, taking a tabletop card game as an example, when the number of cards dealt in the game area is 4, the party who received cards with the sum of points closest to 9 wins; when the number of cards dealt in the game area is 5, the party who received cards with the largest sum of points wins. In other words, for different numbers of cards, the winning rules are different.

Based on the above game scenario, the detection system of the present disclosure can set corresponding conditions based on different numbers of game items in advance and the corresponding conditions also are named as preset conditions hereafter, so that a corresponding condition for determining can be determined based on detected number of game items. A detailed description will be given below in conjunction with FIG. 3.

As shown in FIG. 3, in some implementations, the method of controlling game states of the example of the present disclosure includes following steps S310-S330.

At S310, obtaining the number of game items in the game item operating area and the identification information of each game item by performing game item detection on at least one image frame.

Specifically, in combination with the architecture of the detection system shown in FIG. 1, the sequence of image frames of the game table can be obtained through the image capture device, and the vision unit 300 extracts and detects the at least one image frame in the sequence of image frames through, for example, a convolution algorithm. Therefore, all the game items in the game item operating area can be determined from the image, and then the number of game items in the game item operating area and corresponding identification information can be determined.

In an example, the sequence of image frames indicates a video stream sequence of a tabletop card game. Through perceptual detection on the sequence of image frames, it is determined that the current game item operating area includes a total of 4 cards, two for each of the parties A and B. Here, the identification information of the two cards of Party A are: 6 of hearts and 3 of diamonds; the identification information of the two cards of Party B are: 2 of spades and 3 of diamonds.

At S320, determining a first preset condition corresponding to the number of game items.

In the implementations of the present disclosure, the detection system is preset with different preset conditions based on the number of game items, that is, there is a preset condition corresponding to each of various numbers of game items, where one or more numbers of game items may correspond to one preset condition.

Still taking the above example for illustration, in the case of 4 dealt cards, the preset condition is: the party who received cards with the sum of points closest to 9 wins. In the case of 5 dealt cards, the party who received cards with the largest sum of points wins. Therefore, in an example of the above step S310, the detection system detects, according to the image frame data, that there are a total of 4 cards in the current game item operating area, and then according to the number of cards “4”, the corresponding first preset condition is determined as “the party who received cards with the sum of points closest to 9 wins”.

At S330, determining, in response to determining that the first preset condition is satisfied based on the detected identification information of each game item, that the identification information meets the preset game result generation condition.

Specifically, after the first preset condition is determined, it can be determined whether the first preset condition is satisfied according to the identification information. If the first preset condition is satisfied, it means that a game result can be obtained according to the identification information. If the first preset condition is not satisfied, it means that a game result cannot be obtained according to the identification information.

Still taking the above example for illustration, the identification information of the two cards of Party A are: 6 of hearts 6 and 3 of diamonds; the identification information of the two cards of Party B are: 2 of spades and 3 of diamonds. The first preset condition is that the party who received cards with the sum of points closest to 9 wins. Thus, the sum of points of the two cards received by Party A is 9 points, and the sum of points of the two cards received by Party B is 5 points, and the sum of points of cards received by Party A is closer to 9 points than that of Party B, so that a game processing result can be obtained: Party A wins. That is, it is determined that the first preset condition is satisfied based on the identification information of the game items in the current game item operating area, so that it is determined that the identification information meets the preset game result generation condition.

It can be seen from the above that, in the implementations of the present disclosure, by setting corresponding different preset conditions for different numbers of game items, scenarios with different numbers of game items can be detected, and the applicability of the detection system can be improved.

In the implementations of the present disclosure, in conjunction with the above step S220, the operation of the preset operating object on currency tokens is used as the response condition for state switching. In a real game scenario, a object that is allowed to operate the currency tokens in the currency token operating area is often the dealer. For example, taking the tabletop card game scenario as an example, when the game is in the result processing state, only the dealer can collect the game coins for settlement.

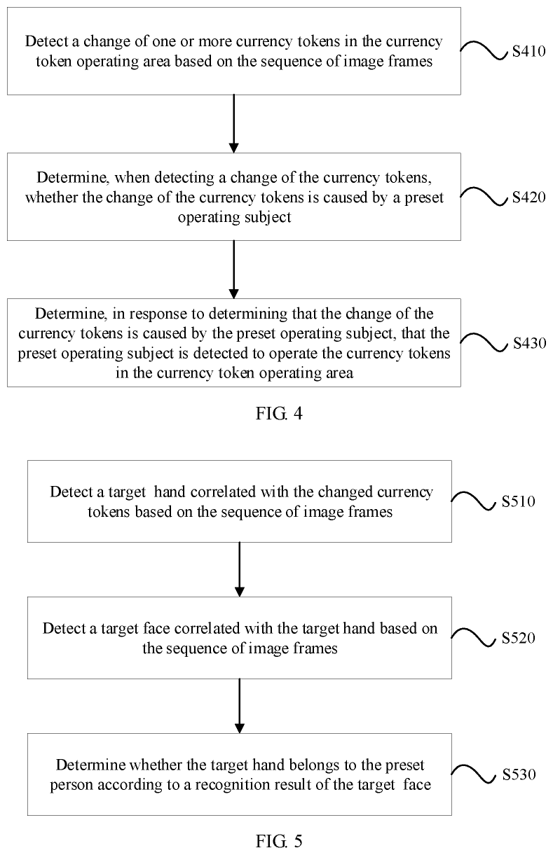

Therefore, in some implementations, the operation on the currency tokens in the currency token operating area is detected based on the sequence of image frames to determine whether the operation is from the preset operating object. Description will be given below in conjunction with FIG. 4.

As shown in FIG. 4, in some implementations, the method of controlling game states of the example of the present disclosure includes the following steps S410-S430.

At S410, detecting a change of one or more currency tokens in the currency token operating area based on the sequence of image frames.

Specifically, by detecting each image frame in the sequence of image frames, the position information of the currency tokens in the currency token operating area in each image frame can be obtained, and based on the position information of two or more adjacent image frames, it can be determined whether the positions of the currency tokens have changed.

However, those skilled in the art can understand that the determination of the change of the currency tokens based on the position information is only an exemplary implementation of the present disclosure. In other implementations, other methods can be used to determine the change of the currency tokens. For example, in some implementations, it can be determined whether the currency tokens have changed based on the change in the amount of the currency tokens in the currency token operating area. Those skilled in the art can understand and fully implement this, which will not be repeated in the present disclosure.

At S420, determining, when detecting a change of the currency tokens, whether the change of the currency tokens is caused by a preset operating object.

Specifically, when the detection system detects a change in the currency tokens, it means that in the real game scenario, someone has manipulated the currency tokens. For example, the dealer collects the currency tokens in the currency token operating area; for another example, the player accidentally touches the currency tokens in the currency token operating area; and so on.

It can be understood that in the real game process, the dealer collecting currency tokens can indicate that the game result has come out, and the game process has entered or is about to enter the stage of game coins recovery and settlement, so the detection system thinks that the game should also be switched from the halt state to the result processing state. However, if a player accidentally touches the currency tokens and causes the currency tokens to change, it does not mean that the current game has entered the result processing state.

Therefore, in the implementations of the present disclosure, it is necessary to further determine whether the change of the currency tokens is caused by a preset operating object.

In an example, taking the tabletop card game scenario as an example, when the detection system detects the movement of the game coins in the currency token operating area, it can further determine whether the person who moved the game coins is a dealer. That is, the preset operating object is the dealer.

In some implementations, it can be determined whether the change of the currency tokens is caused by the preset operating object based on recognition algorithms such as face recognition and hand face correlation, which will be described in the present disclosure below, and will not be described in detail here.

At S430, determining, in response to determining that the change of the currency tokens is caused by the preset operating object, that the preset operating object is detected to operate the currency tokens in the currency token operating area.

Specifically, when it is determined that the change of the currency tokens is caused by the preset operating object, it means that the person operating the currency tokens is the preset person.

For example, taking the above example for illustration, the preset operating object is a dealer, and the currency tokens are game coins. When it is determined that the object operating the game coins is a dealer, it means that the dealer is performing the process of collecting and settling the game coins, so that it can be determined that the preset operating object is detected to operate the currency tokens in the currency token operating area, and the foregoing state switching process can be performed. During the switching process, the game is switched from the halt state to the result processing state.

It can be seen from the above that in the method of the implementation of the present disclosure, whether the operating object is the preset operating object is detected when the currency tokens change, thereby it can reduce the risk of interference from non-preset operating objects, improve the accuracy of state switching, and thereby improve the stability and reliability of the detection system.

In some implementations of a tabletop game scene, for whether the change of the currency tokens is caused by a preset operating object, it can be correlated determined by determining, based on a current operation tool that changes the currency tokens, whether the operating object is a preset operating object. The operation tool can be a hand, a hand-held prop, and so on. By determining whether the operation tool belongs to the preset operating object, it can be determined whether the current operating object is the preset operating object. The description will be given below in conjunction with FIG. 5.

As shown in FIG. 5, in some implementations, the operation tool includes a hand, and the preset operating object includes a preset person. The method of controlling game states of the example of the present disclosure includes the following steps S510-S530.

At S510, detecting a target hand correlated with the changed currency tokens based on the sequence of image frames.

Specifically, an image detection algorithm can be used to detect currency tokens and a hand in the sequence of image frames, so as to determine a correlated hand currently operating the currency tokens, that is, the target hand.

At S520, detecting a target face correlated with the target hand based on the sequence of image frames.

Specifically, after the target hand is determined, based on a hand and face correlation algorithm, detection on the sequence of image frames can be performed to determine a face correlated with the target hand, that is, the target face.

At S530, determining whether the target hand belongs to the preset person according to a recognition result of the target face.

Specifically, after the target face is determined, feature information of the target face can be obtained by performing detection on the sequence of image frames based on a face recognition algorithm. At the same time, facial feature information of the preset person can be stored in advance, so that the recognized feature information of the target face can be compared with the stored facial feature information to obtain the recognition result.

If similarity between the feature information of the target face and the stored facial feature information is greater than a preset threshold, the recognition result is passed, indicating that the target hand belongs to the preset person, and it can be determined that the change of the currency tokens is caused by the preset operating object.

If the similarity between the feature information of the target face and the stored facial feature information is not greater than the preset threshold, the recognition result is failed, indicating that the target hand does not belong to the preset person, and it can also be determined that the change of the currency tokens is not caused by the preset operating object.

It can be seen from the above that in the method of the implementation of the present disclosure, it is determined whether the object operating the currency tokens is the preset operating object through the hand and face correlation and the face recognition algorithm, which can improve the recognition accuracy and thus the accuracy of state switching.

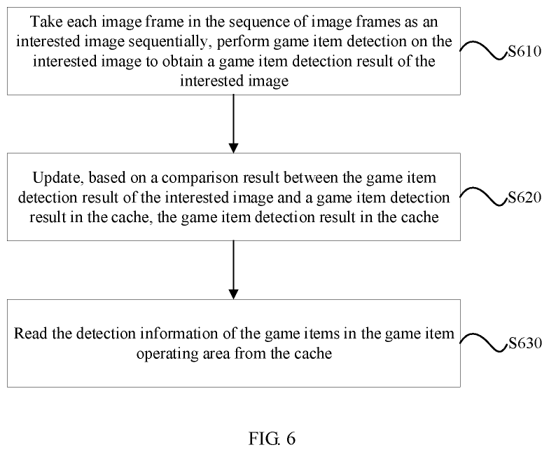

As shown in FIG. 6, in some implementations, the method of controlling game states of the examples of the present disclosure can include the following steps S610-S630.

At S610, sequentially taking each image frame in the sequence of image frames as an interested image, performing game item detection on the interested image to obtain a game item detection result of the interested image.

At S620, updating, based on a comparison result between the game item detection result of the interested image and a game item detection result in the cache, the game item detection result in the cache.

Specifically, the detection system detects each image frame in the sequence of image frames according to the time sequence, and stores the detection result of the game items detected based on the image frame in the cache. At the same time, based on the detection result of the current image frame, the detection result in the cache is compared and updated.

For example, the detection system performs detection based on the (i−1)th image frame, obtains a detection result φi−1 of the game items, and stores the detection result φi−1 in the cache at the same time. Then, the detection is performed based on the i-th image frame to obtain a detection result φi of the game items.

The detection system compares the φi and the φi−1 to obtain similarity between φi and φi−1. If the similarity between the two is less than a preset threshold, it means that the detection result of the i-th image frame is different from that of the (i−1)th image frame, so that the detection result of the i-th image frame φi is used to update the cached detection result φi−1.

Based on the time sequence of the sequence of image frames, the above update process is iteratively performed in turn, so that the detection result in the cache can be updated to the latest state in real time, thereby improving the detection accuracy.

At S630, reading the detection information of the game items in the game item operating area from the cache.

Therefore, the detection system can read the latest detection information from the current cache, and perform the state switching process according to the detection information, which will not be repeated in the present disclosure.

It can be seen from the above that in the method of controlling game states of the implementation of the present disclosure, based on the sequence of image frames, the detection result of a previous image frame is iteratively updated with the detection result of the current image frame, thereby improving the accuracy of the detection system.

In some implementations, the step of determining that the game is in the halt state in the method of controlling game states of the present disclosure can include: based on the sequence of image frames, determining whether a processing operation of the preset operating object meets a preset operating condition; in response to determining that the processing operation does not meet the preset operating condition, switching the game to the halt state.

Specifically, the preset operating object can refer to a player or a dealer participating in the game, and the player or the dealer can operate the game items to perform corresponding processing operations.

Taking a tabletop card game as an example, in some implementations, dealer A can operate cards to deal cards for player B and player C respectively. In an exemplary rule, the dealer A should deal for the player B and the player C with 2 cards respectively, the order of dealing the cards is “player B-player C-player B-player C”. Therefore, the preset operation condition of the detection system is that the dealer A deals cards in the order of “player B-player C-player B-player C”.

In an exemplary scenario, the detection system detects that the card dealing order of the dealer A is “player C-player B-player C-player B”, that is, the card dealing order of the dealer A does not meet the preset operation condition, which indicates a violation action, so that the game can be switched to the halt state.

In some other implementations, an exemplary rule is: a player cannot place game coins during the card dealing stage. Therefore, the preset operation condition of the detection system is that when the game is in the card dealing state, a player cannot place game coins.

In an exemplary scenario, the detection system detects that the player C placed game coins during the process of dealing cards, which indicates a violation action, so that the current game can be switched to the halt state.

It can be understood that the processing operations of the preset operating object and the preset operation condition are not limited to the examples of the present disclosure, and those skilled in the art can set the processing operations and the preset operation condition according to specific implementation scenarios, which are not enumerated in the present disclosure.

In some implementations, when the game is switched to the halt state, the vision unit can send warning information to a background processing unit to remind a background operator of a violation action at a certain game table.

For certain game scenarios, when players participate in the game, the game process is often repeated in a loop, that is, the game will include multiple rounds. Taking the tabletop card game as an example, the card game is often based on “hands”, and a hand of the game will include multiple stages divided according to the present disclosure. Therefore, in some implementations of the present disclosure, one or more hands of games are defined as “one round”.

In an example, one hand of card game indicating one round is taken as an example for illustration. In the card dealing stage of the current round, due to the dealer's mistake in the order of dealing cards, the game was switched from the card dealing state to the halt state by the detection system. In the subsequent real game scenario, the detection system cannot detect identification information due to the player's mistake in placing the back of the card facing up, so a game processing result of this round cannot be determined, and the game cannot resume from the halt state by a state switch.

Based on such a scenario, in some implementations, the method of controlling game states of the implementations of the present disclosure includes: in response to determining that identification information for the current round of the game does not meet the preset game result generation condition, continuing to determine identification information for a next round of the game based on the sequence of image frames of the next round of the game and determine whether the identification information for the next round of the game meets the preset game result generation condition.

In can be seen from the above that, if the identification information of the sequence of image frames obtained in the current round of the game cannot meet the preset game result generation condition, that is, when a game result cannot be determined, the detection system will always remain the game in the halt state. Accordingly, a next round of the game can start and the aforementioned method may be executed again based on the sequence of image frames of the next round, until a game result can be determined for a certain round of the game. That is, the identification information of the certain round meets the preset game result generation condition, and the game can be switched from the halt state to the result processing state.

It can be seen from the above that in the method of controlling game states of the implementation of the present disclosure, it can realize state resuming based on the data of subsequent rounds of the game when resuming from the halt state cannot be achieved in the current round, which avoids the game being stuck in the halt state for a long time, and improves the reliability and stability of the detection system.

In some implementations, on the basis of the above-mentioned automatic switching of the game states, in order to avoid the game being in the halt state for a long time, a manual operation by the user can be set to realize the recovery from the halt state. Specifically, in some implementations, the method of controlling game states exemplified in the present disclosure further includes: when the identification information does not meet the preset game result generation condition, in response to receiving a manual switching instruction for switching the game to a currency token operating state, the game is switched to the currency token operating state, and the detection result of the game item is cleared from the cache.

In one example, a corresponding touch unit can be provided on the front-end game table and/or the back-end processing unit. When the game is in a halt state, the detection system determines that the identification information does not meet the preset game result generation condition, such that the detection system cannot implement automatic state switching. At this time, a front-end or back-end dealer can trigger the touch unit to generate a manual switching instruction, thereby switching the game from the halt state to a corresponding state. In addition, the detection result stored in the cache can be cleared after the state switching.

For example, if the dealer manually triggers the switching from the halt state to the currency token operating state, according to the corresponding manual switching instruction, the current game is controlled to be switched from the halt state to the currency token operating state. For another example, the dealer manually triggers the switching from the halt state to the card dealing state, and the current game is controlled to be switched from the halt state to the card dealing state according to the corresponding manual switching instruction.

It can be seen from the above that in the method of controlling game states of the implementation of the present disclosure, manual state switching can be realized in addition to automatic state switching, which avoids the game being stuck in the halt state, and improves the reliability and stability of the system.

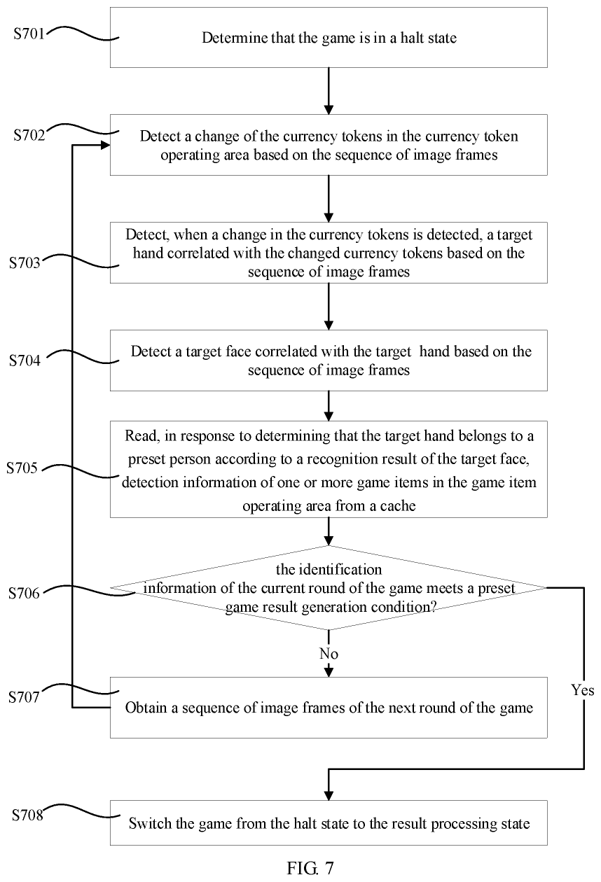

FIG. 7 shows a specific implementation of the method of controlling game states of the present disclosure. In the example of FIG. 7, taking the tabletop card game scenario as an example. The framework of the detection system can be seen in FIG. 1, and a detailed description will be given below with reference to FIG. 1 and FIG. 7.

In this implementation, one hand of card game indicates one game round, and each hand of card game includes three stages: the player placing the game coins, the dealer dealing the cards, and the dealer collecting and settling the game coins. Corresponding to these three stages, the game state at the logic level of the detection system includes a currency token operating state, a card dealing state, and a result processing state in turn.

As shown in FIG. 1 and FIG. 7, the method of controlling game states of this implementation includes the following steps S701-S708.

At S701, determining that the game is in a halt state.

Specifically, the specific description of this step can refer to the aforementioned content regarding to switching the game to the halt state.

For example, in one example, from the sequence of image frames collected by the image capture device 200, the detection system detects a mistake of the dealer in the order of dealing cards, and the vision unit 300 can switch the current game from the card dealing state to the halt state.

In addition, the vision unit 300 can send warning information to the processing unit 400 at the same time to remind the background operator.

At S702, detecting a change of the currency tokens in the currency token operating area based on the sequence of image frames.

At S703, detecting, when a change in the currency tokens is detected, a target hand correlated with the changed currency tokens based on the sequence of image frames.

At S704, detecting a target face correlated with the target hand based on the sequence of image frames.

At S705, reading, in response to determining that the target hand belongs to a preset person according to a recognition result of the target face, detection information of one or more game items in the game item operating area from a cache.

In an example, the change of the currency tokens is: the position of a game coin in the currency token operating area changes.

Based on the sequence of image frames collected by the image capture device 200, when the vision unit 300 detects a change in the position of the game coin in the currency token operating area, the target hand moving the game coin is detected based on the sequence of image frames.

After determining the target hand, based on the hand and face correlation algorithm, detection can be performed on the sequence of image frames to determine the face correlated with the target hand, that is, the target face.

After the target face is determined, the feature information of the target face can be obtained by performing detection on the sequence of image frames with the face recognition algorithm. The recognition result is obtained by comparing the recognized feature information of the target face with the stored facial feature information.

In response to the recognition result being passed, it indicates that the target hand belongs to the preset person, and it can also be determined that the game coin is moved by the dealer. At this time, the detection information of the game item can be read from a system cache, and the detection information can be obtained through, for example, the implementation in FIG. 6, which will not be repeated here.

At S706, determining, based on the collected sequence of image frames, whether the identification information of the current round of the game meets a preset game result generation condition. If the determination result is no, step S707 is performed. If the determination result is yes, step S708 is performed.

At S707, obtaining a sequence of image frames of the next round of the game.

At S708, switching the game from the halt state to the result processing state.

Specifically, reference can be made to the description of the above implementations, which is not repeated here.

It can be seen from the above that in the method of controlling game states of the implementation of the present disclosure, it can realize the detection of the game scene based on computer vision, and ensure the smooth progress of the game process, and when the game is in a halt state, through the detection of the identification information of the game items, the game can be automatically switched from the halt state to the result processing state, thereby ensuring automatic resuming of the game, without requiring the user to perform manual switching, and improving the reliability and stability of the system.

In some implementations, an example of the present disclosure provides an apparatus for controlling game states, which can be applied to, for example, the detection system shown in FIG. 1.

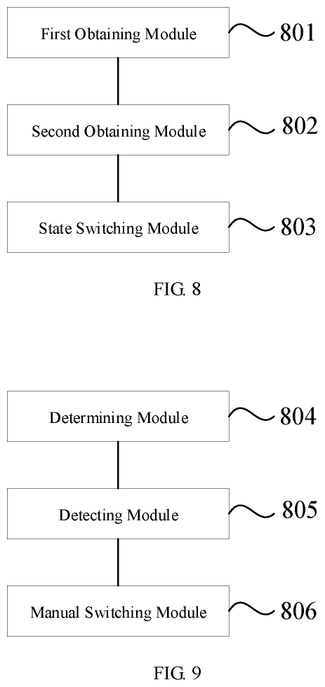

As shown in FIG. 8, in some implementations, the apparatus for controlling game states of the example of the present disclosure includes: a first obtaining module 801 configured to obtain a sequence of image frames of a game table on which a game is in a halt state, where the game table includes a currency token operating area and a game item operating area; a second obtaining module 802 configured to, in response to detecting that one or more currency tokens in the currency token operating area are operated by a preset operating object based on one or more image frames in the sequence of image frames, obtain detection information of one or more game items in the game item operating area from the one or more image frames, where the detection information includes identification information of each of the one or more game items; a state switching module 803 configured to, in a case that the identification information meets a preset game result generation condition, switch the game from the halt state to a result processing state.

It can be seen from the above that in the apparatus for controlling game states of the present disclosure, it can achieve automatic state switch unconceivable to the front-end player, and when the game is in a halt state, the dealer does not need to manually switch to resume the game from the halt state, which ensures the game process be smooth. It can realize continuous detection of the game process, and improve the reliability and stability of the system.

In some implementations, the second obtaining module 802 is specifically configured to: obtain a number of game items in the game item operating area and the identification information of each game item by performing game item detection on the one or more image frames.

As shown in FIG. 9, in some implementations, the apparatus for controlling game states of the example of the present disclosure further includes: a determining module 804 configured to: determine a first preset condition corresponding to the number of game items; and, in response to determining that the first preset condition is satisfied based on the detected identification information of each game item, determine that the identification information meets the preset game result generation condition.

As shown in FIG. 9, in some implementations, the apparatus for controlling game states of the example of the present disclosure further includes: a detecting module 805 configured to detect an operation on one or more currency tokens in the currency token operating area based on the sequence of image frames.

In some implementations, the detecting module 805 is specifically configured to: detect a change of the one or more currency tokens in the currency token operating area based on the sequence of image frames; in response to detecting a change of the one or more currency tokens, determine whether the change of the one or more currency tokens is caused by a preset operating object; and in response to determining that the change of the one or more currency tokens is caused by the preset operating object, determine that the preset operating object is detected to operate the currency tokens in the currency token operating area.

In some implementations, the detecting module 805 is specifically configured to: detect whether an operation tool correlated with the changed currency tokens belongs to the preset operating object based on the sequence of image frames.

In some implementations, the preset operating object includes a preset person, the operation tool includes a hand, and the detecting module 805 is specifically configured to: detect a target hand correlated with the changed currency tokens based on the sequence of image frames; detect a target face correlated with the target hand based on the sequence of image frames; and determine whether the target hand belongs to the preset person according to a recognition result of the target face.

In some implementations, the second obtaining module 802 is specifically configured to: read the detection information of the one or more game items in the game item operating area from a cache, here, the detection information of the one or more game items is generated by: sequentially taking each image frame in the sequence of image frames as an interested image, performing game item detection on the interested image to obtain a game item detection result of the interested image; and based on a comparison result between the game item detection result of the interested image and a game item detection result in the cache, updating the game item detection result in the cache.

As shown in FIG. 9, in some implementations, the apparatus for controlling game states of the example of the present disclosure further includes: a manual switching module 806 configured to, in a case that the identification information does not meet the preset game result generation condition, in response to receiving a manual switching instruction for switching the game to a currency token operating state, switch the game to the currency token operating state, and clear the game item detection result in the cache.

It can be seen from the above that in the apparatus for controlling game states of the implementation of the present disclosure, it can realize the detection of the game scene based on computer vision, and ensure the smooth progress of the game process. And when the game is in a halt state, through the detection of the identification information of the game items, the game state is automatically switched from the halt state to the result processing state, thereby it can ensure automatic resuming of the state, without requiring the user to perform manual switching, and improve the reliability and stability of the system.

In some implementations, the implementations of the present disclosure provide a detection system, including: a processor; and a memory stores computer instructions, and the computer instructions are used to cause the processor to perform the method for controlling game states according to any one of the above implementations.

For the detection system of the present disclosure, it can be implemented with reference to, for example, the implementation shown in FIG. 1.

In some implementations, the implementations of the present disclosure provide a storage medium that stores computer instructions, and the computer instructions are used to cause a computer to perform the method of any one of the above implementations.

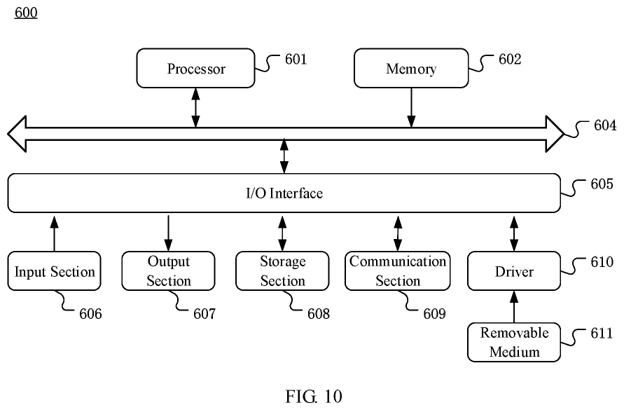

Specifically, FIG. 10 shows a schematic structural diagram of a computer system 10 applicable to perform the method of the present disclosure. Through the system shown in FIG. 10, the corresponding functions of the processor and storage medium can be realized.

As shown in FIG. 10, the computer system 600 includes a processor 601, which can perform various appropriate actions and processes according to a program stored in the memory 602 or a program loaded into the memory 602 from a storage section 608. In the memory 602, various programs and data required for the operation of the system 600 are also stored. The processor 601 and the memory 602 are connected to each other via a bus 604. An input/output (I/O) interface 605 is also connected to the bus 604.

The following components are connected to the I/O interface 605: an input section 606 including a keyboard, a mouse, or the like; an output section 607 including a cathode ray tube (CRT), a liquid crystal display (LCD), and a speaker, or the like; a storage section 608 including a hard disk, or the like; and a communication section 609 including a network interface card such as a LAN card, a modem, or the like. The communication section 609 performs communication processing via a network such as the Internet. The driver 610 is also connected to the I/O interface 605 as required. A removable medium 611, such as a magnetic disk, an optical disk, a magneto-optical disk, a semiconductor memory, or the like, is installed on the drive 610 as required, so that the computer program read from it is installed into the storage section 608 as required.

In particular, according to the implementations of the present disclosure, the above method process can be implemented as a computer software program. For example, the implementations of the present disclosure include a computer program product, which includes a computer program tangibly embodied on a machine-readable medium, and the computer program includes program code for executing the above method. In such an implementation, the computer program can be downloaded and installed from the network through the communication section 609, and/or installed from the removable medium 611.

The flowcharts and block diagrams in the accompanying drawings illustrate the possible implementation architecture, functions, and operations of the system, method, and computer program product according to various implementations of the present disclosure. In this regard, each block in the flowchart or block diagram can represent a module, program segment, or part of a code, and the module, program segment, or part of the code contains one or more executable instructions for realizing the specified logic function. It should also be noted that, in some alternative implementations, the functions marked in the block can also take place in a different order from the order marked in the drawings. For example, two blocks shown in succession can actually be executed substantially in parallel, and they can sometimes be executed in the reverse order, depending on the functions involved. It should also be noted that each block in the block diagram and/or flowchart, and the combination of the blocks in the block diagram and/or flowchart, can be implemented by a dedicated hardware-based system that performs the specified functions or operations, or it can be implemented by a combination of dedicated hardware and computer instructions.

Apparently, the above implementations are merely examples for clear description, and are not intended to limit the implementations. For those of ordinary skill in the art, other changes or modifications in different forms can be made on the basis of the above description. It is not necessary and impossible to list all the implementations here. The obvious changes or changes derived from this are still within the scope of protection created by the present disclosure.

1. A method of controlling game states, comprising:
obtaining a sequence of image frames of a game table on which a game is in a halt state, wherein the game table comprises a currency token operating area and a game item operating area;
obtaining, in response to detecting that one or more currency tokens in the currency token operating area are operated by a preset operating object based on one or more image frames in the sequence of image frames, detection information of one or more game items in the game item operating area from the one or more image frames, wherein the detection information comprises identification information of each of the one or more game items; and
switching, in a case that the identification information meets a preset game result generation condition, the game from the halt state to a result processing state.

2. The method of claim 1, wherein
obtaining the detection information of the one or more game items in the game item operating area from the one or more image frames comprises:
obtaining a number of game items in the game item operating area and the identification information of each game item by performing game item detection on the one or more image frames;
the method further comprises:
determining a first preset condition corresponding to the number of game items; and
determining, in response to determining that the first preset condition is satisfied based on the detected identification information of each game item, that the identification information meets the preset game result generation condition.

3. The method of claim 1, further comprising:
detecting an operation on one or more currency tokens in the currency token operating area based on the sequence of image frames.

4. The method of claim 3, wherein detecting the operation on the one or more currency tokens in the currency token operating area based on the sequence of image frames comprises:
detecting a change of the one or more currency tokens in the currency token operating area based on the sequence of image frames;
determining, in response to detecting a change of the one or more currency tokens, whether the change of the one or more currency tokens is caused by a preset operating object; and
determining, in response to determining that the change of the one or more currency tokens is caused by the preset operating object, that the preset operating object is detected to operate the currency tokens in the currency token operating area.

5. The method of claim 4, wherein determining whether the change of the one or more currency tokens is caused by the preset operating object comprises:
detecting whether an operation tool correlated with the changed currency tokens belongs to the preset operating object based on the sequence of image frames.

6. The method of claim 5, wherein the preset operating object comprises a preset person, the operation tool comprises a hand, and detecting whether the operation tool correlated with the changed currency tokens belongs to the preset operating object based on the sequence of image frames comprises:
detecting a target hand correlated with the changed currency tokens based on the sequence of image frames;
detecting a target face correlated with the target hand based on the sequence of image frames; and
determining whether the target hand belongs to the preset person according to a recognition result of the target face.

7. The method of claim 1, wherein obtaining the detection information of the one or more game items in the game item operating area from the one or more image frames comprises:
reading the detection information of the one or more game items in the game item operating area from a cache, wherein the detection information of the one or more game items is generated by:
sequentially taking each image frame in the sequence of image frames as an interested image;
performing game item detection on the interested image to obtain a game item detection result of the interested image; and
updating, based on a comparison result between the game item detection result of the interested image and a game item detection result in the cache, the game item detection result in the cache.

8. The method of claim 7, in a case that identification information does not meet the preset game result generation condition, the method further comprises:
switching, in response to receiving a manual switching instruction for switching the game to a currency token operating state, the game to the currency token operating state, and
clearing the game item detection result in the cache.

9. A detection system comprising:
at least one processor; and
one or more memories coupled to the at least one processor and storing programming instructions for execution by the at least one processor to perform operations for controlling game states, the operations comprising:
obtaining a sequence of image frames of a game table on which a game is in a halt state, wherein the game table comprises a currency token operating area and a game item operating area;
obtaining, in response to detecting that one or more currency tokens in the currency token operating area are operated by a preset operating object based on one or more image frames in the sequence of image frames, detection information of one or more game items in the game item operating area from the one or more image frames, wherein the detection information comprises identification information of each of the one or more game items; and
switching, in a case that the identification information meets a preset game result generation condition, the game from the halt state to a result processing state.

10. The system of claim 9, wherein
obtaining the detection information of the one or more game items in the game item operating area from the one or more image frames comprises:
obtaining a number of game items in the game item operating area and the identification information of each game item by performing game item detection on the one or more image frames;
the operations further comprise:
determining a first preset condition corresponding to the number of game items; and
determining, in response to determining that the first preset condition is satisfied based on the detected identification information of each game item, that the identification information meets the preset game result generation condition.

11. The system of claim 9, the operations further comprise:
detecting an operation on one or more currency tokens in the currency token operating area based on the sequence of image frames.

12. The system of claim 11, wherein detecting the operation on the one or more currency tokens in the currency token operating area based on the sequence of image frames comprises:
detecting a change of the one or more currency tokens in the currency token operating area based on the sequence of image frames;
determining, in response to detecting a change of the one or more currency tokens, whether the change of the one or more currency tokens is caused by a preset operating object; and
determining, in response to determining that the change of the one or more currency tokens is caused by the preset operating object, that the preset operating object is detected to operate the currency tokens in the currency token operating area.

13. The system of claim 12, wherein determining whether the change of the one or more currency tokens is caused by the preset operating object comprises:
detecting whether an operation tool correlated with the changed currency tokens belongs to the preset operating object based on the sequence of image frames.

14. The system of claim 13, wherein the preset operating object comprises a preset person, the operation tool comprises a hand, and detecting whether the operation tool correlated with the changed currency tokens belongs to the preset operating object based on the sequence of image frames comprises:
detecting a target hand correlated with the changed currency tokens based on the sequence of image frames;
detecting a target face correlated with the target hand based on the sequence of image frames; and
determining whether the target hand belongs to the preset person according to a recognition result of the target face.

15. The system of claim 9, wherein obtaining the detection information of the one or more game items in the game item operating area from the one or more image frames comprises:
reading the detection information of the one or more game items in the game item operating area from a cache, wherein the detection information of the one or more game items is generated by:
sequentially taking each image frame in the sequence of image frames as an interested image;
performing game item detection on the interested image to obtain a game item detection result of the interested image; and
updating, based on a comparison result between the game item detection result of the interested image and a game item detection result in the cache, the game item detection result in the cache.

16. The system of claim 15, in a case that identification information does not meet the preset game result generation condition, the operations further comprise:
switching, in response to receiving a manual switching instruction for switching the game to a currency token operating state, the game to the currency token operating state, and
clearing the game item detection result in the cache.

17. A storage medium comprising:
at least one processor; and
one or more memories coupled to the at least one processor and storing programming instructions for execution by the at least one processor to perform operations for controlling game states, the operations comprising:
obtaining a sequence of image frames of a game table on which a game is in a halt state, wherein the game table comprises a currency token operating area and a game item operating area;
obtaining, in response to detecting that one or more currency tokens in the currency token operating area are operated by a preset operating object based on one or more image frames in the sequence of image frames, detection information of one or more game items in the game item operating area from the one or more image frames, wherein the detection information comprises identification information of each of the one or more game items; and
switching, in a case that the identification information meets a preset game result generation condition, the game from the halt state to a result processing state.
